(19) United States
(12) Patent Application Publication
(10) Pub. No.: US 2024/0020331 A1
(43) Pub. Date: Jan. 18, 2024

(54) SYSTEM AND METHOD FOR ENHANCING A PLANT IMAGE DATABASE FOR IMPROVED DAMAGE IDENTIFICATION ON PLANTS

(71) Applicant: BASF AGRO TRADEMARKS GMBH, Ludwigshafen (DE)

(72) Inventors: Marek Piotr SCHIKORA, Köln (DE); Martin BENDER, Ludwigshafen (DE); Maik ZIES, Köln (DE); Joerg WILDT, Köln (DE); Mirwaes WAHABZADA, Köln (DE)

(21) Appl. No.: 18/023,517

(22) PCT Filed: Sep. 2, 2021
(86) PCT No.: PCT/EP2021/074258

§ 371 Date: Feb. 27, 2023

(30) Foreign Application Priority Data
Sep. 4, 2020 (EP) 20194648.0

(51) Int. Cl. G06F 16/55; G06F 16/587; G06Q 50/02; G06F 16/23; G06V 10/74; G06V 10/764; G06V 20/10; G06V 10/94; G06V 10/774; G06V 10/77; G06V 10/82

(52) U.S. Cl. CPC G06F 16/55; G06F 16/587; G06Q 50/02; G06F 16/2379; G06V 10/761; G06V 10/764; G06V 20/188; G06V 10/945; G06V 10/774; G06V 10/7715; G06V 10/82; G06V 2201/10

(57) ABSTRACT

Computer-implemented method and system (100) for enhancing a plant image database (230) for improved damage identification on plants. The system receives a real-world image (91) of a plant (11), recorded at a particular geographic location (2), together with image metadata comprising location data (LD1) indicating the particular geographic location (2), and a time stamp (TS1) indicating the point in time (3) when the real-world image (91) was recorded. A damage identifier (110), trained for identifying damage classes associated with damage symptoms present on plants of particular plant species, generates, from the real-world image (91), an output including a damage class (DC1) for the damage symptoms on the real-world image. A similarity checker (120) determines feature similarities of the real-world image with selected images (232, 233, 234, 235) in a plant image database (230), and further identifies at least a subset (230s) of the selected images having a feature similarity with the real-world image exceeding a minimum similarity value (124). The generated damage class (DC1) and the images of the subset (230s) with respective damage classes and plant species identifier are provided to a user (9). In response, the system receives from the user (9) a confirmed damage class (CDC1) for the real-world image (91). A database updater (140) of the system updates the plant image database (230) by storing the received real-world image (91) together with its plant species identifier, its location data, its time stamp and the confirmed damage class.

### TECHNICAL FIELD

The present invention generally relates to electronic data processing, and more particularly, relates to image processing methods, computer program products and systems for enhancing a plant image database for improved damage identification on plants.

### BACKGROUND

For farmers it is important to ensure that they do not miss the right timepoint for the application of plant protection products if plant damage risks (e.g., damages as a result of pest and disease, necrosis, drought, etc.) appear in an agricultural field. This is advantageous for ensuring that the potential yield of the field is not reduced by the appearance of biotic or abiotic stress in the field.

Existing image processing solutions provide plant damage analysis capabilities to the farmer via applications which can classify plant damages for particular plant species by using neural networks. However, the quality of the classification results depends significantly on the quality of the training images used for training the neural network, as well as on the quality of the image which is used as test input. In image classification, it can happen that the classification result is associated with a low confidence value. In such case, the classification result typically has low or no value for the farmer to decide about the right plant protection product. For instance, if the quality of the test put image is not sufficient in that the damage symptoms on the plant (e.g., on the leaves of the pant) are indistinct, or if the damage class is not well represented in the training data (unbalanced training data set), the damage recognition task by the neural network can fail and mislead the farmer with classification results with low confidence.

### SUMMARY

There is therefore a need to provide decision support to a farming user by reliable damage classification to identify the correct damage type (class) which is present on an image taken from a plant with damage symptoms in an agricultural field.

The herein disclosed solution to this technical problem is based on the enhancement of a plant image database for improved damage identification on plants. In short, a damage identification module (e.g., a convolutional neural network (CNN), a naïve Bayesian classifier or any other appropriate machine learning model), which has been trained for damage identification of plant damage, is applied to a test input image recorded in an agricultural field showing a plant growing in said field. Typically, the plant shows some symptoms which are seen as potential damage symptoms by a farming user. However, damage symptoms may not be identifiable for a user in the visible light spectrum in which case the user may record an image simply to check the health state of the plant. Therefore, the test input image (real-world image) may be recorded in the field by the farming user with a mobile camera device (e.g., a smartphone or any other suitable image recording device) while inspecting the field status, or, alternatively, with other camera devices such as a near-infrared (NIR) camera. For example, if potential damage symptoms are not recognizable for the user in the range of visible wave length they may be made visible by a respective presentation of the NIR image for the user. Alternatively, test input images may be recorded by mobile cameras carried by unmanned aerial vehicles such as drones while flying over the field, or by statically mounted cameras which are installed in the field for monitoring certain parts of the field. The output of the CNN is a damage class (i.e. a damage type or category) which is supposed to be present on the plant on the test input image. Typically, the damage class is determined together with a confidence value for the classification result. The determined damage class is provided to the user. Thereby, the damage class may indicate a damage which is associated with the damage symptoms present on the plant. However, it may happen that no damage can be identified in which case the damage class can be “no damage” or the like. “no damage” can indicate that a damage present on the plant could not be identified by the damage identification module, or it can indicate that no damage is present and the plant is healthy. Optionally, the confidence value is also provided to the user. From the confidence value more advanced users may derive information about the reliability of the classification result.

Together with this output, one or more images which are similar to the test input image, and which had been recorded in the neighborhood of the agricultural field in the more recent past (details described below) are presented to the farming user together with the respective plant species and damage type information for each of the presented similar images. Such similar images are retrieved from an image database where images recorded by the same or other farming users (or monitoring devices) have been stored in the past. The user can now assess the similar images visually and come to a more educated decision regarding the damage class present on the test input image. The assessment by the user based on the similar images may come to the same classification result as the damage identification module, or it may come to a different result—in particular when the damage classification result is associated with a low confidence value. The user now provides his or her assessment of the damage class as classification input to the image database where the test input image is then stored together with the user's classification input. The user input is considered as a highly reliable assessment of the damage class (or damage type) and can be used as ground truth for further training the damage identification module to arrive at improved plant damage classification results for future damage class predictions on future test inputs.

In more detail, the technical solution to the above technical problem can be implemented in various embodiments, such as a computer implemented method for enhancing a plant image database for improved damage identification on plants, a computer system adapted to execute such method, and a computer program product which includes instructions, that when executed by one or more processing units of the computer system, cause the system to execute said method.

The term “plant damage” or “damage” as used in the context of the present application is any deviation from the normal physiological functioning of a plant which is harmful to a plant, including but not limited to plant diseases (i.e. deviations from the normal physiological functioning of a plant) caused by
a) fungi (“fungal plant disease”),
b) bacteria (“bacterial plant disease”)
c) viruses (“viral plant disease”),
d) insect feeding damage,
e) plant nutrition deficiencies,
f) heat stress, for example temperature conditions higher than 30° C.,
g) cold stress, for example temperature conditions lower than 10° C.,
h) drought stress,
i) exposure to excessive sun light, for example exposure to sun light causing signs of scorch, sun burn or similar signs of irradiation,
j) acidic or alkaline pH conditions in the soil with pH values lower than pH 5 and/or pH values higher than 9,
k) salt stress, for example soil salinity,
l) pollution with chemicals, for example with heavy metals, and/or
m) fertilizer or crop protection adverse effects, for example herbicide injuries
n) destructive weather conditions, for example hail, frost, damaging wind.

In a preferred embodiment, “plant damage” or “damage” includes plant diseases (i.e. deviations from the normal physiological functioning of a plant) caused by fungi, insect feeding damage, plant nutrition deficiencies, heat stress, cold stress, or destructive weather conditions (for example hail, frost, damaging wind). In a more preferred embodiment, “plant damage” or “damage” are plant diseases (i.e. deviations from the normal physiological functioning of a plant) caused by fungi or insect feeding damage.

The term “damage class” as used in the context of the present application is understood to be any type of classification relating to or associated with plant damage, including but not limited to for example “no damage”, “severe damage caused by Septoria (as an example for fungi)”, “leaf chewing damage caused by insects”, “medium damage caused by cold stress”, “low degree of damage caused by nitrogen deficiency” etc.

The term “time stamp” or “timestamp” as used in the context of the present application is understood to be any information or data identifying or useful for identifying when a specific event occurred, preferably at least indicating the date of said specific event, more preferably at least indicating the date and the time in hours and minutes of said specific event, most preferably at least indicating the date and the time in hours, minutes and seconds of said specific event.

type of classification relating to or associated with plant damage, including but not limited to for example “no damage”, “severe damage caused by Septoria (as an example for fungi)”, “leaf chewing damage caused by insects”, “medium damage caused by cold stress”, “low degree of damage caused by nitrogen deficiency” etc.

In one embodiment, the computer-implemented method starts with receiving a real-world image (test input image) of a plant in an agricultural field. The test input image is recorded at a particular geographic location. The test input image has image metadata comprising location data indicating the particular geographic location, and a time stamp indicating the point in time when the real-world image was recorded. It is a standard function of most digital image recording devices that an integrated location sensor (e.g., a GPS sensor or the like) determines the location data of the geographic location where the image was recorded. Further, it is a standard function of such devices to record time and date when the picture is taken. The time stamp and location data are stored as metadata of the test input image and, therefore, received together with said image via an appropriate interface component. It is well known in the art to communicatively couple image recording devices with computer systems to transfer the recorded images for storage of further image processing tasks to such computer systems.

In one embodiment, the damage identification module can be implemented as a convolutional neural network CNN, which has been trained for identifying damage classes associated with visual damage symptoms on plants of particular plant species, generates, from the received real-world image, an output including a damage class for the damage symptoms on the real-world image, and an associated confidence value. The CNN can be based on any classification convolutional neural network topology for classifying the input images according to plant disease specific features. For example, the CNN topology may be pre-trained with Imagenet or another dataset suitable for posterior fine-tuning for crop disease identification. For example, a residual neural network may be used as backbone, such as for example the ResNet50 deep convolutional neural network with 50 layers. Other variants of the ResNet family (e.g., ResNet101, ResNet152, SE-ResNet, ResNeXt, SE-ResNeXt, or SENet154) or other image classification neural network families (e.g. DenseNet, Inception, MobileNet, EfficientNet, Xception or VGG) may be used as well. Such CNNs for plant damage identification and their training are for example described in: Picon, A. et al, 2019. Crop conditional Convolutional Neural Networks for massive multi-crop plant disease classification over cell phone acquired images taken on real field conditions. Computers and Electronics in Agriculture November 2019. This approach is also described in the international patent application PCT/EP2020/063428.

In an alternative embodiment, the damage identification module can be implemented with a naïve Bayesian classifier as disclosed in the international patent application WO2017194276 (A1).

In some embodiments, the received image metadata may already include a plant species identifier specifying the plant species to which the plant on the real-world image belongs. For example, a user taking the real-world image may tag the recorded test input accordingly. In cases where the image is taken by an unmanned aerial vehicle such as drone or a static camera, the camera device may have the information about the plant species growing in the respective field and add such information to the metadata.

In some embodiments, the damage identification module may be further trained for automatically identifying the plant species to which the plant on the real-world image belongs.

A similarity checker module determines feature similarities of the real-world image with selected images in a plant image database. The plant image database can include all kinds of images showing plants of different species with different damage symptoms recorded at any time anywhere on earth. Each image in the image database is labeled with a plant species identifier indicating a crop plant shown on the image, a damage class indicating the damage type on said crop plant, as well as location data and time stamp data indicating where and when the respective image was recorded. The image labels may result from user annotations, automatic annotations made by an algorithm, or from metadata of the recorded images.

The selected images are selected from the image database with a spatio-temporal filter function in that the selected images were recorded within a predefined time window before the time stamp of the test input image and at geographic locations within a predefined vicinity area of the geographic location where the test input image was recorded. With regard to the spatial filter dimension, the predefined vicinity area is typically defined such that in this area similar growth conditions for agricultural plants prevail. In other words, temperature, humidity, etc. in the vicinity area provide similar conditions for the grown plants so that similar damage symptoms can be expected. For example, the predefined vicinity area may be defined as circle with a predefined radius and the received location data defining the center of the circle. Advantageous radius lengths are lower than (as preferred embodiments) 200 km, 190 km, 180 km, 170 km, 160 km, 150 km, 140 km, 130 km, 120 km, 110 km, 100 km, 90 km, 80 km, 70 km, 60 km, 50 km, 40 km, 30 km, 20 km, 10 km, 5 km, 2 km, 1 km, 500 m, 100 m (as one preferred embodiment: 50 km). However, depending on the climate situation in the vicinity of the agricultural field, smaller or even larger radius lengths may be useful. Any other definition of the vicinity area (e.g. by other geometric shapes likes rectangles/squares, oval shapes, or even free from shapes) may be used to define the vicinity area. A vicinity area may also be an area belonging to the same administrative region—such as village, town, district (“Kreis” in Germany), Federal State, country. A vicinity area may also be an area having the same or similar geographic or climate characteristics—such as river systems, (micro-)climate zones.

With regard to the temporal filter dimension, typically it is most useful to consider a time interval in the range of 1 day, 2 days, 3 days, 4 days, 5 days, 6 days, 7 days, 8 days, 9 days, 10 days, 12 days, 14 days, 16 days, 18 days, 20 days, 22 days, 24 days, 26 days, 28 days, 30 days, 32 days; in another preferred embodiment: similar seasonal dates 1, 2, 3, 4, 5, years ago (for example March 2019, March 2018, March 2017, March 2016, March 2015). Again, the time window is selected by taking into account time periods with similar conditions for the development of the damage symptoms. That is, images from the same day but one year earlier are likely less useful that images recorded during the past two weeks.

The similarity checker first applies the spatio-temporal filter function to the image database to retrieve candidate images taken within the vicinity area and time window, and then identifies at least a subset of the selected images having a feature similarity with the real-world image exceeding a minimum similarity value. The subset may even consist of a single image. However, advantageously multiple similar images can be identified. The feature similarities between the real-world image and the selected images may be determined by the similarity checker using a convolutional neural network (which can be the same CNN as above or a further CNN) trained to extract feature maps from the real-world image and the selected images. It can then compute distances between respective pairs of feature maps where a low distance value indicates a high feature similarity. A person skilled in the art may use other known similarity measures to determine the feature similarity between the real-world image (test input) and the selected images as retrieved from the image database. For example, the last layer of a CNN trained for identifying damages decides about the damage class for a respective test input image. The before-last layer of the CNN includes a corresponding feature vector for the test input image. By comparing feature vectors of two different test inputs a feature similarity between the two images can be computed. For example, a Euclidian Distances or a Mahalonobis Distance can be computed between the two feature vectors resulting in a value for the feature similarity, i.e. the feature similarity can be determined using calculation or computation based on Euclidian distance or Mahalonobis distance between the two feature vectors. In another embodiment, the feature similarity can be determined as or is the cosine similarity, which is the cosine of the angle between the two feature vectors. Therefore, the feature similarity may be a similarity value determined using calculation or computation based on Euclidian distance or Mahalonobis distance between the two feature vectors or determined as cosine similarity, i.e. as cosine of the angle between the two feature vectors. The minimum similarity value can be a predefined threshold value for filtering out all selected images which have a similarity value less than or equal to the minimum similarity value.

A user interface module/component provides the generated damage class (as generated by the CNN)—optionally together with the associated confidence value—to the farming user. Further, in parallel, the images of the subset are provided to the user with damage classes and plant species identifiers as indicated by their respective labels. The user interface may be implemented by standard I/O means allowing the user to view visual information and to enter data in response. For example, any front-end device such as a mobile client in a smart phone or tablet computer may be used for the visualization. The interface module is configured to communicate with such front-end devices.

Once the farming user has evaluated all the provided information regarding the potential damage type on the plant of the test input, the user provides feedback via the user interface module which then receives a confirmed damage class for the real-world image (test input) from the user. The confirmed damage class can be interpreted as a ground truth for the real-world image. The confirmed damage class may deviate from the determined damage class. In particular in such cases where the CNN was trained with an unbalanced training data set where images showing plants of the plant species on the test input with respective damage symptoms were underrepresented, or in cases where the test input image is of low quality, the determined confidence value may be low and the provisioning of the subset of similar images supports the user to make a better informed decision for the confirmed damage class by simply comparing the images of the subset with the real-world image situation.

In another preferred embodiment, the term “confirmed damage class” may include user validation data relating to or indicating the degree or likelihood of correctness of the generated damage class from the user's perspective. For example, the user validation data may include the user's assessments “the generated damage class is incorrect” or “the generated damage class is very likely incorrect” or “the generated damage class is likely correct”. The user's assessments such as “the generated damage class is incorrect” are also very useful for updating and/or enhancing the plant image database.

The confirmed damage type is received by a database updater module which updates the plant image database by triggering storage of the received real-world image together with its plant species identifier, its location data, its time stamp and the confirmed damage class.

In one embodiment, the updater may also trigger the storing of the determined damage class with the real-world image. Storing both, the determined and the confirmed damage class, in the image database can be advantageous for improving the training of the CNN. The CNN may then be re-trained based on the updated plant image database including the location data, time stamp, determined damage class and confirmed damage class of the stored real-world image as features.

Further aspects of the invention will be realized and attained by means of the elements and combinations particularly depicted in the appended claims. It is to be understood that both, the foregoing general description and the following detailed description are exemplary and explanatory only and are not restrictive of the invention as described.

### SHORT DESCRIPTION OF THE FIGURES

FIG. 1 includes a block diagram of a computer system for enhancing a plant image database for improved damage identification on plants according to an embodiment;

FIG. 2 is a simplified flowchart of a computer implemented method for enhancing a plant image database for improved damage identification on plants according to an embodiment;

FIG. 3A illustrates the spatial filtering function of a spatio-temporal filter component according to an embodiment;

FIG. 3B illustrates the temporal filtering function of a spatio-temporal filter component according to an embodiment;

FIG. 4A illustrates extraction of feature maps from plant images according to one embodiment;

FIG. 4B illustrates the computation of pairs of feature maps and a similarity filtering step to filter out images associated with feature similarities below a predefined threshold value; and

FIG. 5 is a diagram that shows an example of a generic computer device and a generic mobile computer device, which may be used with the techniques described herein.

### DETAILED DESCRIPTION

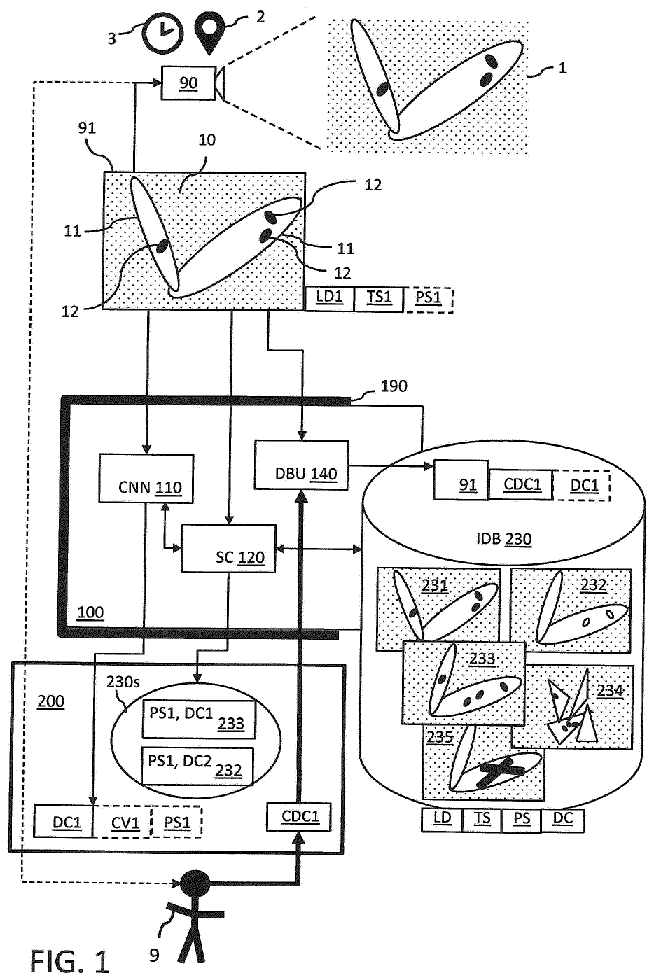

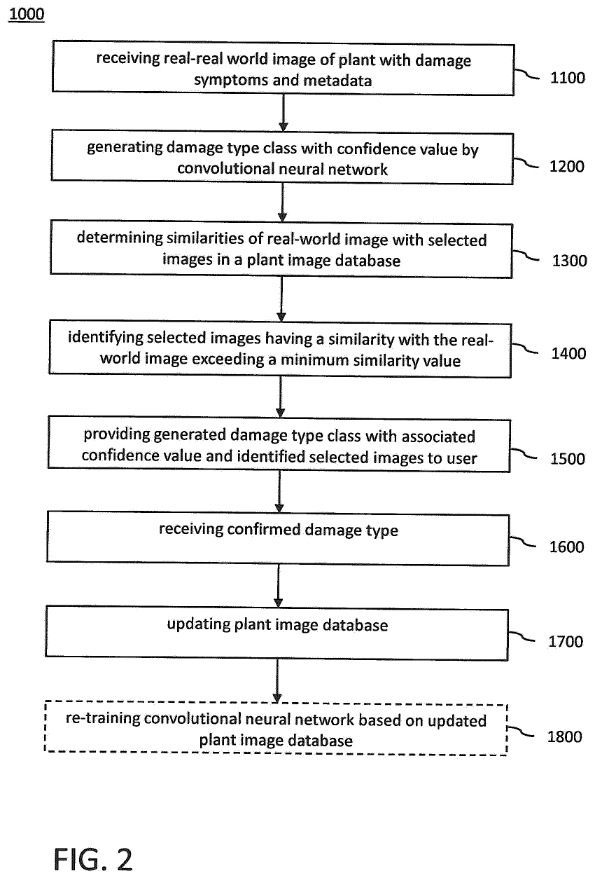

FIG. 1 includes a block diagram of a computer system 100 for enhancing a plant image database for improved damage identification on plants. FIG. 2 is a simplified flowchart of a computer implemented method 1000 for enhancing a plant image database for improved damage identification on plants. The method 1000 may be executed by the computer system 100 when running a respective computer program which implements the modules of the computer system 100. The computer system 100 is now described in the context of the computer-implemented method 1000 with using the reference numbers of both figures.

The computer system 100 has an interface 190 which allows a communicative coupling between the computer system 100 and a digital camera device 90. The camera device 90 may be integrated in a handheld communication device (e.g., smart phone or tablet computer) carried by a farming user 9 who performs inspection of plants growing in an agricultural field 1. Alternatively, the camera may be statically in the field 1 or it may be carried by an inspection robot (e.g., an unmanned aerial vehicles such as a drone, or a land robot). The camera device 90 records a real-world image 91 of a plant which is growing in the field and shows some damage symptoms. Damage symptoms often appear on the leaves of a plant but may also appear on the stem or panicle or other plant elements. In FIG. 1, the damage symptoms are represented by black elliptic dots 12.

In the example, it is assumed that the damage symptoms appear on the leaves of the plant 11 only (represented by the larger white elliptic shapes). For reasons of simplicity, other plant elements are not shown. It can be advantageous to take the image 91 from a zenithal view so that the background 10 of the image may show the soil of the field 1. Typically, for images taken from a zenithal view, the automatic segmentation of plant leaves is an easier task than for images showing a plant from a side view with other plants as background. However, there are known methods which can segment leaves in both situations as cited further down below. In real images, there may be weeds spread over the soil. There are also systems available which can separate weeds from crop plant leaves. The image 91 is recorded by the camera 90 at a particular geographic location 2 in the field.

Typically, digital camera devices are equipped with a GPS sensor which is used to automatically determine the geo-coordinates of the location where the image is taken and stores such location data LD1 as metadata for the recorded image 91. Also, each image taken by a digital camera is stored with metadata about the point in time 3 the image was recorded. Such time metadata is referred to as time stamp TS1 herein. Optionally, the user 9 may add a plant species identifier PS1 to the metadata of the image 91. This can be supported by a corresponding user interface coupled with the camera device 90 which allows the user to input a unique code (e.g., EPPO Code) or select a name (e.g., from a suitable drop down menu displayed via the user interface) specifying the plant species to which the crop plant shown on the image belongs.

The computer system 100 then receives 1100, via interface 190, the real-world image 91 with the respective metadata. The image 91 is then provided as a test input to a damage identification module which is implemented in the example embodiment as a convolutional neural network 110 (CNN) of the system 100. CNN 110 has been trained for identifying damage classes associated with damage symptoms present on plants of particular plant species and provides an output including a damage class DC1 for the damage symptoms on the real-world image, and an associated confidence value CV1. Advantageous implementations for CNN architectures serving this purpose when being trained respectively are described in detail in the previously mentioned paper publication of Picon et al. Alternatively, other classification algorithms may be used for the implementation of the damage identification module, such as for example the above-mentioned naïve Bayesian classifier.

In the optional embodiment with a plant species identifier PS1 being received as metadata of the image, the plant species identifier may also serve as an input for the CNN 110. However, the CNN 110 can also be trained to automatically identify the plant species of the plant 11 on the image 91 in which case the plant species is also an output of CNN 110.

The CNN output is presented to the farming user 9 via the user interface of a mobile communication device 200 which is communicatively coupled with system 100. In some embodiments, the digital camera 90 may be an integral part of the mobile communication device 200. In other embodiments, the camera is not associated with the user 9 (e.g., the static or robot carried camera scenarios), but the output of the CNN is nevertheless provided to a separate mobile device of the user 9 which is used by the user to interact with the system 100 via its interface 190. For example, the user may actively request the latest image taken by a robot at the current location of the user 9. The current location of the user can be determined by a GPS sensor integrated in the mobile communication device 200.

From the output of the CNN 110, the user gets a first information about the damage class DC1 associated with the damaged plant. Optional confidence value CV1 provides the information about how reliable the damage classification is. Optionally, the confidence value may be provided to the farming user together with the classification result. For more advanced users, the confidence value may provide valuable information about how strongly the generated damage class should be taken into account when providing feedback in the form of the confirmed damage class. Optionally, the plant species can be presented, too. In embodiments, where the CNN determines the plant species identifier, this identifier PS1 is always presented together with the damage class CD1.

Further, a similarity checker 120 (SC) of system 100 determines 1300 feature similarities of the real-world image 61 with selected images 232, 233, 234, 235 in a plant image database 230. The plant image database 230 stores a large amount of real-world plant images with damage symptoms recorded at many different locations on earth over a period of time which typically covers at least several months into the past. As described later, recorded images which have been processed in accordance with the herein described approach are finally stored in the image database. Other image sources may be included, too. All images in the image database are tagged with metadata including a plant species identifier (for the plant species to which the plant on the image belongs), a damage class (indicating the type of damage present on said plant), location data (indicating the geographic location where the respective image was recorded) and time stamp data (indicating the point in time when said image was recorded).

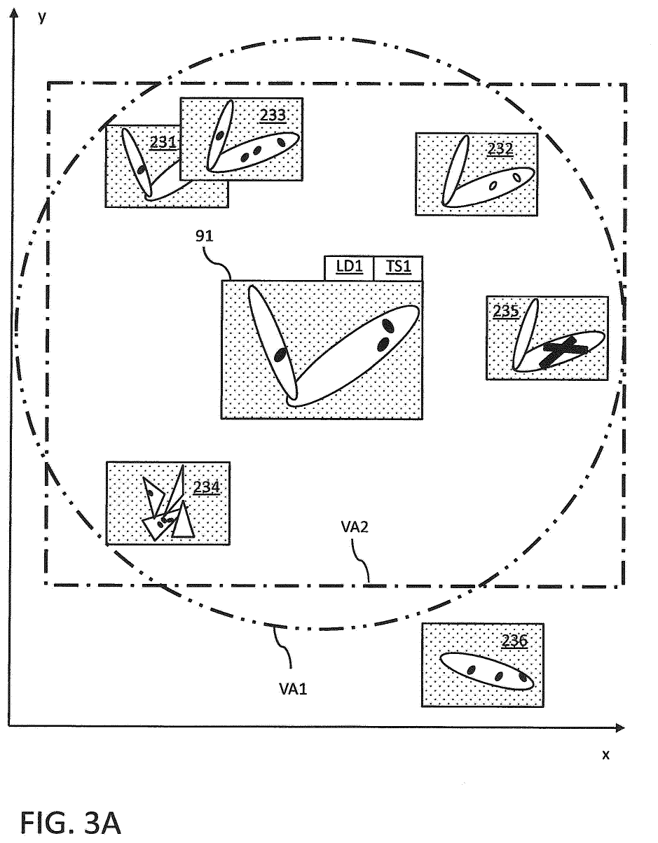

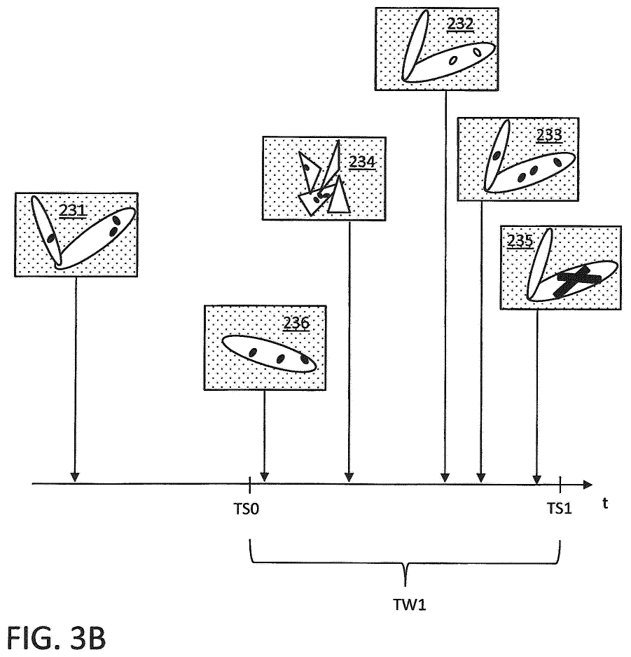

To identify 1400 the selected images 232, 233, 234, 235 in the image database 230, SC 120 uses a spatio-temporal filter function. The spatial dimension of the filter function is illustrated in more detail in FIG. 3A, and the temporal dimension of the filter is illustrated in FIG. 3B.

Turning briefly to FIG. 3A, the figure illustrates the geographic locations (via geo-coordinates (x, y)) where the images 231 to 236 in the image database and the real-world image 61 have been recorded. The images 231 to 236 are all in the near or far surroundings of the geographic location specified by the location data LD1 of the image 91. Images 231 and 233 were recorded in the same field (indicated by the overlap of the images) and show plants of the same plant species with similar damage symptoms. Image 232 was recorded at a different location (in a different field) showing the same plant species as images 231, 233 but different damage symptoms. Image 235 is recorded again at a different location (in a different field) that grows the same plant species as the previous images but shows different damage symptoms (indicated by the crossed black bars on a leave). Image 236 was recorded again at a different location (in a different field than the previously described images) and shows a plant of the same species with the same damage symptoms as the images 231 and 233. Finally, image 234 was again recorded in a different field and shows a plant species different form all the other images but with damage symptoms that are similar the damage symptoms in images 231, 233, 236.

The spatial filter function is now filtering the images in the image database to select potential candidates for the similarity check with image 91 by using a predefined vicinity area around the recording location of image 91 as the spatial filter criterion. The example shows to different shapes of vicinity areas. In a first implementation, the vicinity area VA1 is implemented as a circle with a give radius with the location data LD1 of the image 91 at the center of the circle. The radius can be selected according to criteria like similar climate conditions, similar ground properties etc. In a second implementation, the vicinity area VA2 is defined as a rectangle with the location data LD1 at the center of mass of the rectangle VA2. It is to be noted, that any appropriate shape may be defined for the vicinity area dependent on the real-world conditions around the field where image 91 was recorded. Also, there is no need that the location data LD1 are in the center of mass of the vicinity area. For example, in the field of image 91 is located directly at the foot of a mountain, the vicinity area may only extend to the other sides of the field because in the mountain fields may not exist.

The spatial filter function now identifies all images in the image database which were recorded at locations inside the predefined vicinity area. In the example, the same set of candidate images 231 to 235 would be identified by both vicinity areas VA1, VA2 and only the image 236 is filtered out by the spatial filter function as being recorded outside the vicinity area.

Turning briefly to FIG. 3B, the figure illustrates the time stamps (by arrows) representing the time points on the time axis t at which the images 231 to 236 were recorded in comparison to the time stamp TS1 of image 91 (not shown in FIG. 3B). A predefined time window TW1 defines a time interval before TS1 which is set as filter criterion to identify candidate images that were recorded within a time span that is considered to be meaningful for performing a similarity check. The setting of the time window may take into account the weather conditions over the past days, weeks or even months, the growth stage of the plants, etc. In the example, the images 232 to 236 were all recorded within the predefined time window TW1, whereas image 231 (from the same field 233) was recorded in the previous season) and is therefore filtered out by the temporal filter function.

The final result of the selected images 232, 233, 234, 235 is the potentially interesting image set (interesting for the user) of the result of the spatial filter function and the result of the temporal filter function.

Turing back now to FIG. 1, SC120 identifies 1400 at least a subset 230s of the selected images 232, 233, 234, 235 having a feature similarity with the real-world image 901 exceeding a minimum similarity value. As the goal is to identify images which show plants of the same species as image 91 with similar damage symptoms, the overall similarity between the image 91 and the selected images is irrelevant. Instead, the information about the similarly of various plant elements shown on the different images (e.g., the similarities of the leaf shapes) is important to identify images with plants of the same species. With regards to the damage symptoms it is completely irrelevant where on a leaf (or other plant elements) the symptom is located. Rather, the appearance of the symptom in terms of its color, shape, size etc. is important. In other words, the features characterizing the different plant species and damage symptoms on the images provide the relevant information of said images to be compared when checking the similarity. Accordingly, in the example, the images 232, 233 are identified as images where the feature similarity with image 91 exceeds a predefined threshold (i.e. the minimum similarity value) and are therefore provided by SC 120 as similar images in subset 230s to the user 9.

A person skilled in the art can use different similarity metrics to determine the feature similarity between images. Feature similarly indices are often used for the assessment of image quality (e.g., Lin Zhang et al., FSIM: A Feature Similarity Index for Image Quality Assessment, in IEEE Transactions on Image Processing 20(8):2378-2386, September 2011; Yang Li, Shichao Kan, and Zhihai He: Unsupervised Deep Metric Learning with Transformed Attention Consistency and Contrastive Clustering Loss, in: arXiv:2008.04378v1 [cs.CV] 10 Aug. 2020 (URL: https://arxiv.org/pdf/2008.04378.pdf); Mang Ye, Xu Zhang, Pong C. Yuen, Shih-Fu Chang: Unsupervised Embedding Learning via Invariant and Spreading Instance Feature, in: arXiv:1904.03436v1 [cs.CV] 6 Apr. 2019 (URL: https://arxiv.org/pdf/1904.03436.pdf); Florian Schroff, Dmitry Kalenichenko, James Philbin: FaceNet: A Unified Embedding for Face Recognition and Clustering, in: arXiv:1503.03832v3 [cs.CV] 17 Jun. 2015 (URL: https://arxiv.org/pdf/1503.03832.pdf); Nicolas Turpault; Romain Serizel; Emmanuel Vincent: Semi-supervised Triplet Loss Based Learning of Ambient Audio Embeddings, in: ICASSP 2019-2019 IEEE International Conference on Acoustics, Speech and Signal Processing (ICASSP) (URL: https://ieeexplore.ieee.org/abstract/document/8683774)

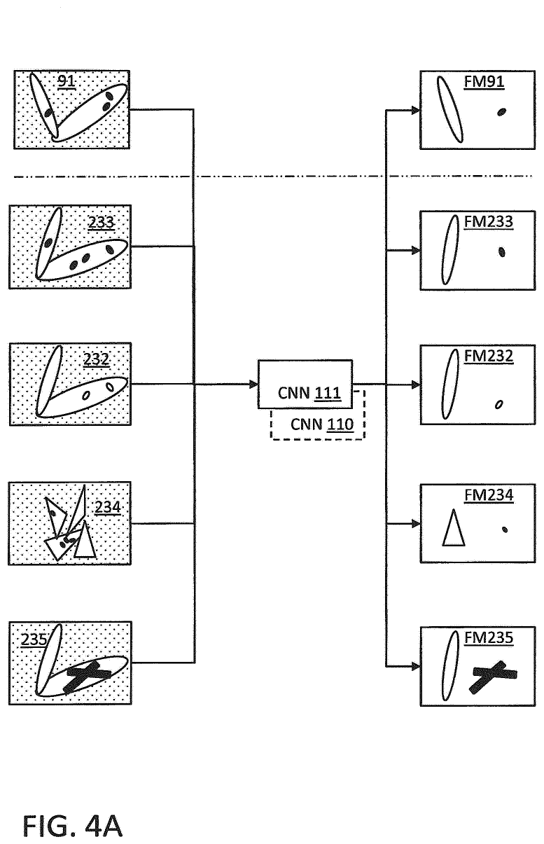

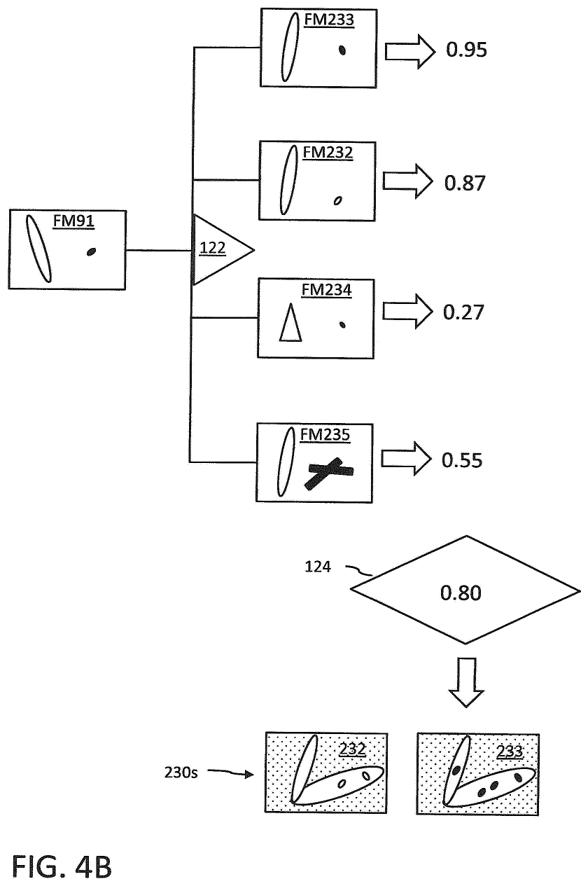

In FIG. 4A, a schematic view of feature maps used for feature similarity identification is described which is advantageous in the context of the herein described approach. CNN 111 is used to generate feature maps FM* from the respective images. CNN 111 is of course trained accordingly so that in particular such features are extracted which are characteristic of the respective plant species and damage symptoms. Advantageously CNN 110 (cf, FIG. 1) can be reused for this task. The real-world image 91 is fed into the CNN and the corresponding feature map FM91 is generated by the CNN. The feature map in the example includes the features of the leaves of the corresponding plant species (e.g., leaf shape, color, etc.) and the features of the damage symptoms on the leaves (e.g., shape color, size, etc.). For simplicity, the aggregate leaf and damage symptom features are shown in the figure. In reality, each of such aggregate features corresponds to a plurality of different features of which a person skilled in the field of image processing by convolutional neural networks is well aware. Beneath the dash-dotted line the selected images of the image database are shown with the corresponding simplified feature maps.

FIG. 4B illustrates the computation of the feature similarities for the respective pairs feature maps with each pair including the feature map FM91 of the real-world image 91 and one of the feature maps FM232 to FM235 of the selected images. The feature similarity of each of the pairs is determined by a feature similarity computation module 122 which computes distances between respective pairs of the feature maps. For example, a Euclidean distance metrics or other appropriate distance metrics may be used. Thereby, a low distance value indicates a high feature similarity between the feature maps of the respective pair. In the example the following feature similarities are computed for the following feature map pairs of FIG. 4B:
FM91/FM232: 0.87
FM91/FM233: 0.95
FM91/FM234: 0.27
FM91/FM235: 0.55

In the example, a minimum similarity value 124 of “0.80” is set. Dependent on the quality of the images in the image database and the desired filtering strength SC 120, a more appropriate minimum similarity value can be set as threshold by the skilled person to ensure that only images with sufficient feature similarity are included in the subset 230s presented to the user. In the example, the selected images 234 and 235 are filtered out so that only the selected images 232, 233 remain in the subset 230s. The remaining images are then presented together with the CNN 110 output to the user 9. In the example, the damage symptoms on the image 233 have a similar appearance as the damage symptoms on image 234. Both images show the same plant species and the corresponding feature maps only differ in some features (e.g., the color) related to the damage symptoms leading to relatively high feature similarities for both images. However, whereas image 233 shows the same plant species with same damage class as the real-world image 91, image 234 only shows the same plant species but with a different damage class. Therefore, it may be preferable to also filter out image 232 from the subset 230s. For example, this can be achieved by raising the minimum similarity value to “0.90”.

However, in the given example of FIG. 4B and FIG. 1, both images 232, 233 are provided 1500 to the user 9 with the respective plant species PS1, PS1 and damage class DC2, DC1 information together with the generated damage class DC1 with its associated confidence value CV1. The user 9 now assesses the images of the presented subset 230s in view of the classification result of CNN 110 by comparing the captured real-world image 91 with the similar images retrieved from the image database. In the present example, the user comes to the conclusion that image 233 actually shows the same plant species PS1 with damage symptoms of the same damage class DC1 as on the real-world image 91, whereas image 232 only conforms with image 91 with regard to the plant species but not with regard to the damage class.

The user 9 now enters a confirmed damage class CDC1 for the real-world image 91 via the user interface of the mobile communication device 200 which is received 1600 by a database updater module 140 (DBU) of system 100. DBU 140 then initiates the updating 1700 of the plant image database 230 in that the real-world image 91 is now stored together with its plant species identifier PS1, its location data LD1, its time stamp TS1 and the confirmed damage class CDC1. Optionally, the database update may also store the generated damage class DC1 with the image 91. This can be advantageous in cases where the CNN 110 has provided a different damage class (e.g., DC2) and the user, based on the visual comparison with the images of subset 230s, nevertheless comes to the conclusion that the correct damage class should be DC1. In such cases, storing also the incorrectly generated damage class can be useful information when retraining the CNN 110 based on the updated image database.

That is, when re-training 1800 damage identification module (e.g., CNN) 110 based on the updated plant image database 230 including the location data, time stamp, determined damage class and confirmed damage class of the stored real-world image as features, the prediction accuracy of damage identification module 110 can be improved over time as the confirmed damage class information provides reliable ground truth information for the re-training of damage identification module 110.

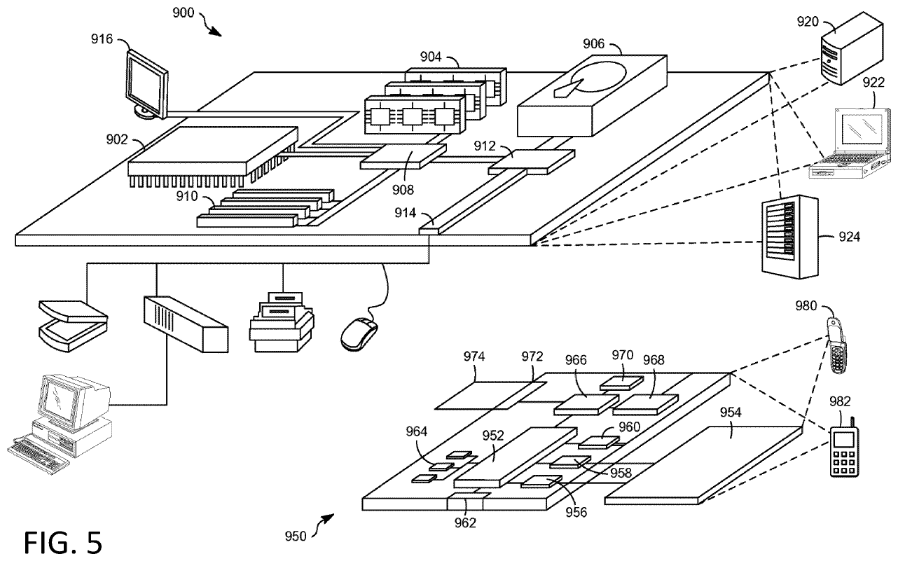

FIG. 5 is a diagram that shows an example of a generic computer device 900 and a generic mobile computer device 950, which may be used with the techniques described here. Computing device 900 is intended to represent various forms of digital computers, such as laptops, desktops, workstations, personal digital assistants, servers, blade servers, mainframes, and other appropriate computers. Ideally, device 900 has a GPU adapted to process machine learning algorithms. Generic computer device 900 may correspond to the computer system 100 of FIG. 1. Computing device 950 is intended to represent various forms of mobile devices, such as personal digital assistants, cellular telephones, smart phones, and other similar computing devices. For example, computing device 950 may be used as a GUI frontend device for a user to capture test input images and provide them to the computer device 900, and in turn, receive from the computer device, a classification result together with further similar images. Further, computing device 950 may serve as data input front-end device enabling the user to provide feedback to computing device 900. Computer device 950 may correspond to mobile communication device 200 of FIG. 1. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processing units and/or multiple buses may be used, as appropriate, along with multiple memories and types of memory. Also, multiple computing devices 900 may be connected, with each device providing portions of the necessary operations (e.g., as a server bank, a group of blade servers, or a processing device).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processing units. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 984 may also be provided and connected to device 950 through expansion interface 982, which may include, for example, a SIMM (Single In Line Memory Module) card interface. Such expansion memory 984 may provide extra storage space for device 950, or may also store applications or other information for device 950. Specifically, expansion memory 984 may include instructions to carry out or supplement the processes described above, and may include secure information also. Thus, for example, expansion memory 984 may act as a security module for device 950, and may be programmed with instructions that permit secure use of device 950. In addition, secure applications may be provided via the SIMM cards, along with additional information, such as placing the identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 984, or memory on processor 952, that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 980 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing device that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing device can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

The following embodiments, “Embodiment 1” to “Embodiment 16”, are the preferred embodiments of the present invention:

Embodiment 1: A computer-implemented method (1000) for enhancing a plant image database for improved damage identification on plants, the method comprising:
receiving (1100) a real-world image (91) of a plant (11), recorded at a particular geographic location (2), together with image metadata comprising location data (LD1) indicating the particular geographic location (2), and a time stamp (TS1) indicating the point in time (3) when the real-world image (91) was recorded;
generating (1200), from the real-world image (91), by a damage identification module (110) trained for identifying damage classes associated with damage symptoms present on plants of particular plant species, an output including a damage class (DC1) for the damage symptoms on the real-world image;
determining (1300) feature similarities of the real-world image with selected images (232, 233, 234, 235) in a plant image database (230) with the selected images being recorded within a predefined time window (TW1) before the time stamp and at geographic locations within a predefined vicinity area (VA1, VA2) of the particular geographic location, and wherein each of the selected images (232, 233, 234, 235) is labeled with a plant species identifier, a damage class, location data and time stamp data;
identifying (1400) at least a subset (230s) of the selected images having a feature similarity with the real-world image exceeding a minimum similarity value (124);
providing (1500), to a user (9), the generated damage class (DC1) and the images of the subset (230s) with respective damage classes and plant species identifiers;
receiving (1600), from the user (9), a confirmed damage class (CDC1) for the real-world image (91); and
updating (1700) the plant image database (230) by storing the received real-world image (91) together with its plant species identifier, its location data, its time stamp and the confirmed damage class.

Embodiment 2: The method of Embodiment 1, wherein confirmed damage class includes user validation data relating to or indicating the degree or likelihood of correctness of the generated damage class from the user's perspective.

Embodiment 3: The method of Embodiment 1, wherein the received image metadata further comprises a plant species identifier (PS1) specifying the plant species to which the plant (11) on the real-world image (91) belongs.

Embodiment 4: The method of Embodiment 1, wherein the damage identification module (110) is further trained for identifying the plant species (PS1) to which the plant (11) on the real-world image (91) belongs.

Embodiment 5: The method of any of the previous Embodiments, wherein updating (1700) further comprises storing the determined damage class (DC1) with the real-world image (91).

Embodiment 6: The method of Embodiment 5, further comprising:
re-training (1800) the damage identification module (110) based on the updated plant image database (230) including the location data, time stamp, determined damage class and confirmed damage class of the stored real-world image as features.

Embodiment 7: The method of any of the previous Embodiments, wherein feature similarities between the real-world image and the selected images are determined by the similarity checker using a convolutional neural network (110, 111), trained to extract feature maps from the real-world image (91) and the selected images, and computing distances between respective pairs of feature maps where a low distance value indicates a high feature similarity.

Embodiment 8: The method of any of the previous Embodiments, wherein the trained damage identification module is a classification neural network.

Embodiment 9: A computer program product for enhancing a plant image database for improved damage identification on plants, the computer program product, when loaded into a memory of a computing device and executed by at least one processor of the computing device, causing the at least one processor to execute the steps of the computer-implemented method according to any one of the previous Embodiments.

Embodiment 10: A computer system (100) for enhancing a plant image database for improved damage identification on plants, comprising:
an interface component (190) configured to receive a real-world image (91) of a plant (11), recorded at a particular geographic location (2), together with location data (LD1) indicating the particular geographic location (2), and a time stamp (TS1) indicating the point in time (3) when the real-world image was recorded;
a damage identification module (110), trained for identifying damage classes associated with damage symptoms present on plants of particular plant species, configured to generate, from the real-world image (91), an output including a damage class (DC1) for the damage symptoms on the real-world image;
a similarity checker module configured to determine feature similarities of the real-world image with selected images (232, 233, 234, 235) in a plant image database (230) with the selected images being recorded within a predefined time window (TW1) before the time stamp and at geographic locations within a predefined vicinity area (VA1, VA2) of the particular geographic location, and wherein each of the selected images (232, 233, 234, 235) is labeled with a plant species identifier, a damage class, location data and time stamp data, and further configured to identify at least a subset (230s) of the selected images having a feature similarity with the real-world image exceeding a minimum similarity value;
the interface component (190) further configured to provide, to a user, the generated damage class and the images of the subset (230s) with respective damage classes and plant species identifiers; and to receive from the user, a confirmed damage class (CDC1) for the real-world image (91); and
a database updater module (140) configured update of plant image database (230) by triggering the storage of the received real-world image (91) together with its plant species identifier, its location data, its time stamp and the confirmed damage class.

Embodiment 11: The system of Embodiment 10, wherein the received image metadata further comprises a plant species identifier (PS1) specifying the plant species to which the plant (11) on the real-world image (91) belongs.

Embodiment 12: The system of Embodiment 10, wherein the damage identification module (110) is further trained for identifying the plant species (PS1) to which the plant (11) on the real-world image (91) belongs.

Embodiment 13: The system of any of the Embodiments 10 to 12, wherein the update of the plant image database further comprises storage of the determined damage class (DC1) with the real-world image (91).

Embodiment 14: The system of Embodiment 13, further comprising:
a training module configured to re-training the damage identification module (110) based on the updated plant image database (230) including the location data, time stamp, determined damage class and confirmed damage class of the stored real-world image as features.

Embodiment 15: The system of any of the Embodiments 10 to 14, wherein the similarity checker (120) is further configured to determine the feature similarities between the real-world image and the selected images by using a convolutional neural network (110, 111), trained to extract feature maps from the real-world image (91) and the selected images, and by computing distances between respective pairs of feature maps where a low distance value indicates a high feature similarity.

Embodiment 16: The method of any of the Embodiments 10 to 15, wherein the trained damage identification module is a classification neural network.

1. A computer-implemented method (1000) for enhancing a plant image database for improved damage identification on plants, the method comprising:
receiving (1100) a real-world image (91) of a plant (11), recorded at a particular geographic location (2), together with image metadata comprising location data (LD1) indicating the particular geographic location (2), and a time stamp (TS1) indicating the point in time (3) when the real-world image (91) was recorded;
generating (1200), from the real-world image (91), by a damage identification module (110) trained for identifying damage classes associated with damage symptoms present on plants of particular plant species, an output including a damage class (DC1) for the damage symptoms on the real-world image;
determining (1300) feature similarities of the real-world image with selected images (232, 233, 234, 235) in a plant image database (230) with the selected images being recorded within a predefined time window (TW1) before the time stamp and at geographic locations within a predefined vicinity area (VA1, VA2) of the particular geographic location, and wherein each of the selected images (232, 233, 234, 235) is labeled with a plant species identifier, a damage class, location data and time stamp data;
identifying (1400) at least a subset (230s) of the selected images having a feature similarity with the real-world image exceeding a minimum similarity value (124);
providing (1500), to a user (9), the generated damage class (DC1) and the images of the subset (230s) with respective damage classes and plant species identifiers;
receiving (1600), from the user (9), a confirmed damage class (CDC1) for the real-world image (91); and
updating (1700) the plant image database (230) by storing the received real-world image (91) together with its plant species identifier, its location data, its time stamp and the confirmed damage class.

2. The method of claim 1, wherein the received image metadata further comprises a plant species identifier (PS1) specifying the plant species to which the plant (11) on the real-world image (91) belongs.

3. The method of claim 1, wherein the damage identification module (110) is further trained for identifying the plant species (PS1) to which the plant (11) on the real-world image (91) belongs.

4. The method of claim 1, wherein updating (1700) further comprises storing the determined damage class (DC1) with the real-world image (91).

5. The method of claim 4, further comprising:
re-training (1800) the damage identification module (110) based on the updated plant image database (230) including the location data, time stamp, determined damage class and confirmed damage class of the stored real-world image as features.

6. The method of claim 1, wherein feature similarities between the real-world image and the selected images are determined by the similarity checker using a convolutional neural network (110, 111), trained to extract feature maps from the real-world image (91) and the selected images, and computing distances between respective pairs of feature maps where a low distance value indicates a high feature similarity.

7. The method of claim 1, wherein the trained damage identification module is a classification neural network.

8. A computer program product for enhancing a plant image database for improved damage identification on plants, the computer program product, when loaded into a memory of a computing device and executed by at least one processor of the computing device, causing the at least one processor to execute the steps of the computer-implemented method according to claim 1.

9. A computer system (100) for enhancing a plant image database for improved damage identification on plants, comprising:
an interface component (190) configured to receive a real-world image (91) of a plant (11), recorded at a particular geographic location (2), together with location data (LD1) indicating the particular geographic location (2), and a time stamp (TS1) indicating the point in time (3) when the real-world image was recorded;
a damage identification module (110), trained for identifying damage classes associated with damage symptoms present on plants of particular plant species, configured to generate, from the real-world image (91), an output including a damage class (DC1) for the damage symptoms on the real-world image;
a similarity checker module configured to determine feature similarities of the real-world image with selected images (232, 233, 234, 235) in a plant image database (230) with the selected images being recorded within a predefined time window (TW1) before the time stamp and at geographic locations within a predefined vicinity area (VA1, VA2) of the particular geographic location, and wherein each of the selected images (232, 233, 234, 235) is labeled with a plant species identifier, a damage class, location data and time stamp data, and further configured to identify at least a subset (230s) of the selected images having a feature similarity with the real-world image exceeding a minimum similarity value;
the interface component (190) further configured to provide, to a user, the generated damage class and the images of the subset (230s) with respective damage classes and plant species identifiers; and to receive from the user, a confirmed damage class (CDC1) for the real-world image (91); and
a database updater module (140) configured update of plant image database (230) by triggering the storage of the received real-world image (91) together with its plant species identifier, its location data, its time stamp and the confirmed damage class.

10. The system of claim 9, wherein the received image metadata further comprises a plant species identifier (PS1) specifying the plant species to which the plant (11) on the real-world image (91) belongs.

11. The system of claim 9, wherein the damage identification module (110) is further trained for identifying the plant species (PS1) to which the plant (11) on the real-world image (91) belongs.

12. The system of claim 9, wherein the update of the plant image database further comprises storage of the determined damage class (DC1) with the real-world image (91).

13. The system of claim 12, further comprising:
a training module configured to re-training the damage identification module (110) based on the updated plant image database (230) including the location data, time stamp, determined damage class and confirmed damage class of the stored real-world image as features.

14. The system of claim 9, wherein the similarity checker (120) is further configured to determine the feature similarities between the real-world image and the selected images by using a convolutional neural network (110, 111), trained to extract feature maps from the real-world image (91) and the selected images, and by computing distances between respective pairs of feature maps where a low distance value indicates a high feature similarity.

15. The method of claim 9, wherein the trained damage identification module is a classification neural network.
